(19) United States
(12) Patent Application Publication
(10) Pub. No.: US 2016/0098728 A1
(43) Pub. Date: Apr. 7, 2016

(54) Communication Method And System With DTA Register Architecture

(71) Applicant: Piotr Nawrocki, Inowroclaw (PL)

(72) Inventor: Piotr Nawrocki, Inowroclaw (PL)

(21) Appl. No.: 14/571,219

(22) Filed: Dec. 15, 2014

(30) Foreign Application Priority Data
Oct. 4, 2014 (EP) 14460060.8
Oct. 4, 2014 (EP) 14460061.6

(51) Int. Cl. G06Q 30/00; H04W 4/02

(52) U.S. Cl. CPC G06Q 30/018; H04W 4/021

(57) ABSTRACT

Method and system of communication with DTA registry architecture, on the example of the DTA registry system—the method of verifying the legality of products, allowing the monitoring, control, and systematizing of intellectual rights of artists and authors, as well as the legality of a product and the exchange of economic information.

### RELATED APPLICATIONS

This application claims priority to European Patent Application No. EP14460060.8, filed Oct. 4, 2014, entitled Communication Method And System With Information Exchange Architecture Designed To Handle And Control The Legality Of Products, and to European Patent Application No. EP14460061.6, filed Oct. 4, 2014, entitled Communication Method And System With DTA Register Architecture, both of which are hereby incorporated herein by reference in their entireties.

### CROSS-REFERENCE TO RELATED APPLICATIONS

The present application is related to U.S. application Ser. No. ______ [Attorney Docket No. 16019-307US] entitled Communication Method And System To Process And Control The Legality Of Products filed simultaneously with the present application, the entire contents of which are hereby incorporated by reference.

### FIELD OF THE INVENTION

The present invention relates to a method and system of communication with DTA registry architecture, on the example of the DTA registry system—the method of verifying the legality of products, allowing the monitoring, control, and systematizing of intellectual rights of artists and authors, as well as the legality of a product and the exchange of economic information.

### FIELD OF THE INVENTION

On the external borders of the European Union, EU customs seize an annual average of more than 103 million products which are believed to breach intellectual property rights. In the published report of the Commission on the enforcement of the EU customs intellectual property rights, the number of items detained by customs almost doubled compared to the previous year, for example: from 43,500 in 2009 to almost 80,000 in 2010. In 2011, for the first time, the Commission's report also stated the value of the goods detained is estimated to be over 1 billion Euro. Among the most often seized goods are cigarettes (34 percent), office supplies (9 percent), other tobacco products (8 percent), labels, tags and signs (8 percent), clothing (7 percent) and toys (7 percent). 14.5 percent of the seized items are household use items, such as shampoos, soaps, medicines or small appliances (hair dryers, shavers, computer parts) that can potentially endanger the lives and health of consumers.

As highlighted in the Europe 2020 strategy, intellectual property protection is important for the EU economy and it is the driving force for further growth in areas such as research, innovation and employment. Effective enforcement of intellectual property rights is also important due to the fact that some counterfeit goods (such as groceries, toiletries, and articles intended for children), produced without any regulation, can pose a serious threat to the health and life of EU citizens.

Appropriate cooperation with international trading partners can also significantly help prevent exports to the EU of goods infringing intellectual property rights as well as improve the detection of such cases. In 2009 the EU and China signed an Action Plan focusing on improving cooperation in the field of enforcement of intellectual property rights by customs authorities (see IP/09/193).

Cooperation with industry also is of great importance to ensure proper identification of goods infringing intellectual property rights. Businesses may request the intervention of customs in case of suspicion that their intellectual property rights are violated, and the information provided by industry helps customs services better target the inspections they conduct. The Commission has prepared a manual for copyright holders to help them in the submission of applications and is in direct contact with the private sector to determine the areas in which it is possible to further improve the inspection process.

Due to the scale of counterfeiting, both governmental units and the private sector find it extremely hard to control the legality and origin of manufactured products.

### OBJECTS AND SUMMARY OF THE INVENTION

To facilitate the above activities, a registry system codenamed DTA was created, which this solution is part of.

A primary aspect of the method and system of communication with the architecture of the DTA registry by the invention is the use and combination of known technologies including the Internet, Near Field Communication (NFC) technology and the mechanism of product location, geotagging, the possibility of full identification, and implementation of storage systems, using a device such as a smartphone, creating, in effect, a mobile tool for copyright and industrial rights protection, as well as determining the legality of a product.

Telecommunications and communications applications and solutions are used in the system, including: NFC (Near Field Communication)—for encrypted product identification; Bluetooth—for encrypted exchange of information; GPS (Global Positioning System)—now available in smartphones for automatic search for the location of a controlled product; S Beam—for encrypted product identification; USB—for encrypted exchange of information; a mobile phone location using GPS for deletion of data in case of loss or theft of the phone login and access password; and use of module or fingerprints scanning application; identification of biometric characteristics such as a photograph of the holder, a fingerprint, an eyeball scan, etc. allow official control unit, or institutions which checks are ordered to confirm the identification in the process.

For secure data transmission and information authentication, secure encryption algorithms are used.

At the time of downloading the purchased application an encryption code is programmed in it, which at the time of product control will serve as an authenticity identifier of the read data. The system uses mechanisms with a high degree of control encryption during the whole process of data exchange between the application and the system, and during the transmission and storage of classified information. The method and the mode of mechanism connection provide uniqueness of the system and the control application.

In order to verify a product location, the system uses location-based services, e.g., GPS, by determining and entering the location in the system to process the data which allows for preparation of a map of distribution of the products and for other statistical purposes.

The unique application interface for control authorities is specially designed for exchange of information from the mobile application between the system and external databases.

### BRIEF DESCRIPTION OF THE DRAWINGS

Operation of the system according to the invention is shown in more detail in various embodiments in the accompanying illustrative material, in which:

FIG. 1 illustrates a first screen of an application in accordance with the present invention;

FIG. 2 illustrates a second screen of an application in accordance with the present invention;

FIG. 3 illustrates a third screen of an application in accordance with the present invention;

FIG. 4 illustrates a fourth screen of an application in accordance with the present invention;

FIG. 5 illustrates a fifth screen of an application in accordance with the present invention;

FIG. 6 illustrates a sixth screen of an application in accordance with the present invention;

FIG. 7 illustrates a seventh screen of an application in accordance with the present invention;

FIG. 8 illustrates an eighth screen of an application in accordance with the present invention;

FIG. 9 illustrates a ninth screen of an application in accordance with the present invention;

FIG. 10 illustrates a then screen of an application in accordance with the present invention;

FIG. 11 illustrates an eleventh screen of an application in accordance with the present invention;

FIG. 12 illustrates a twelfth screen of an application in accordance with the present invention.

### DESCRIPTION OF EMBODIMENTS

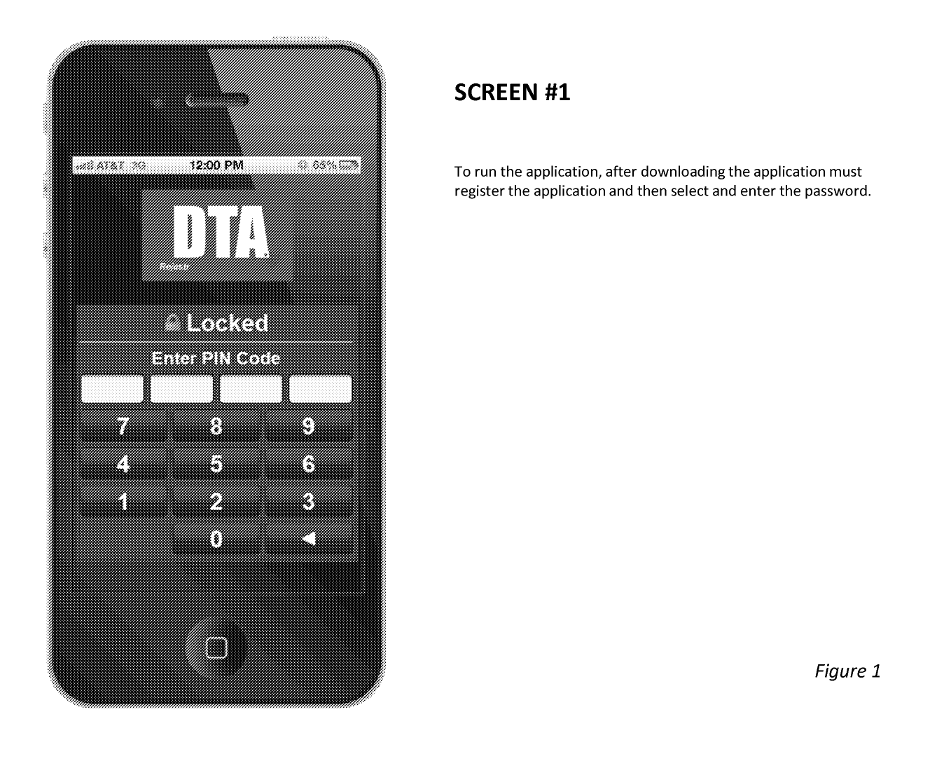

Referring to FIG. 1, the user first downloads the application from the Internet. To run the application, the user must register it and then select and enter a password. The registry provides complete information about the products using the Internet access.

In the case of product inspection it is not required to connect to the network because it also works off-line.

All screen illustrations are illustrative only and non-limiting.

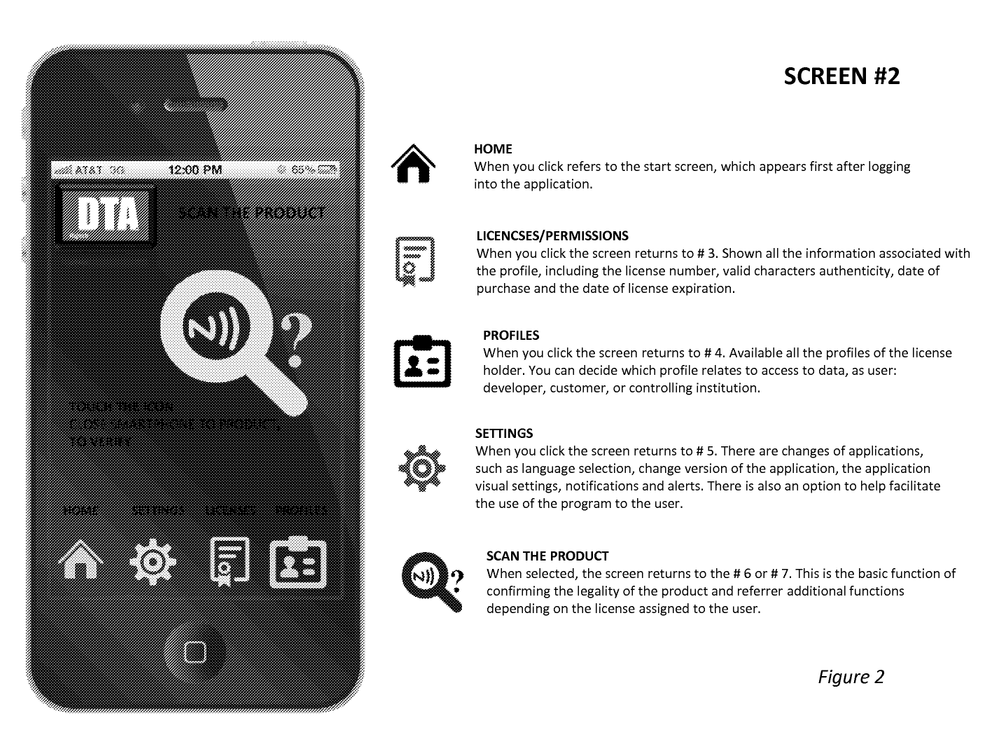

Referring to FIG. 2, the main screen is shown and is the starting point for the application and all of its available features. When you click “HOME,” the application goes to the start screen, which appears first after logging into the application.

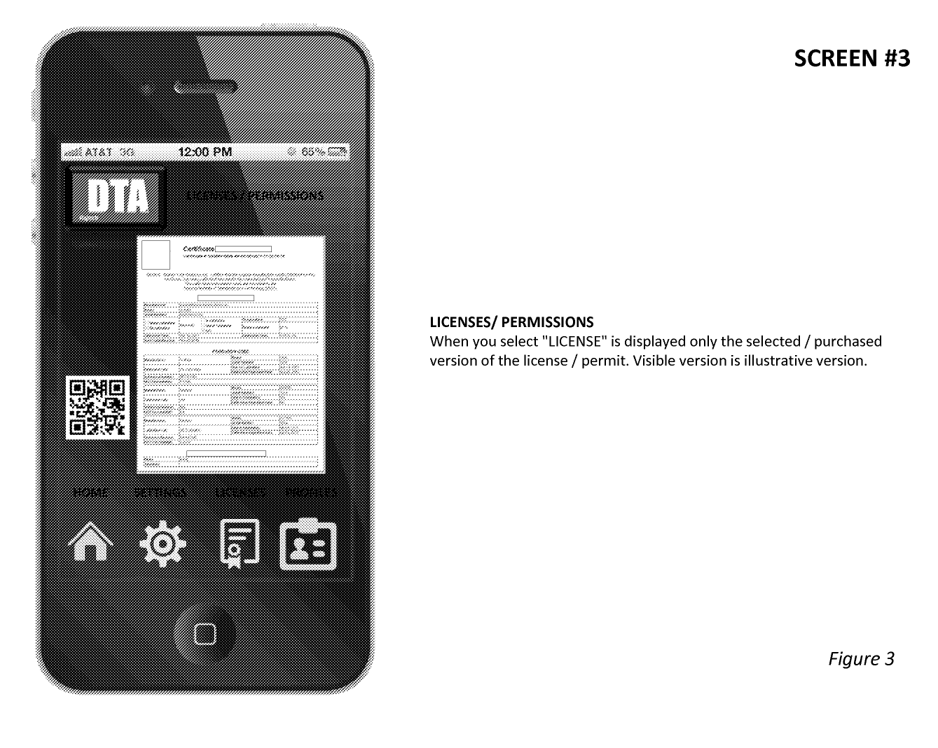

When you click “LICENCES/PERMISSIONS,” the screen goes to the screen of FIG. 3. This screen shows all the information associated with the profile, including the license number, valid characters authenticity, date of purchase and the date of license expiration.

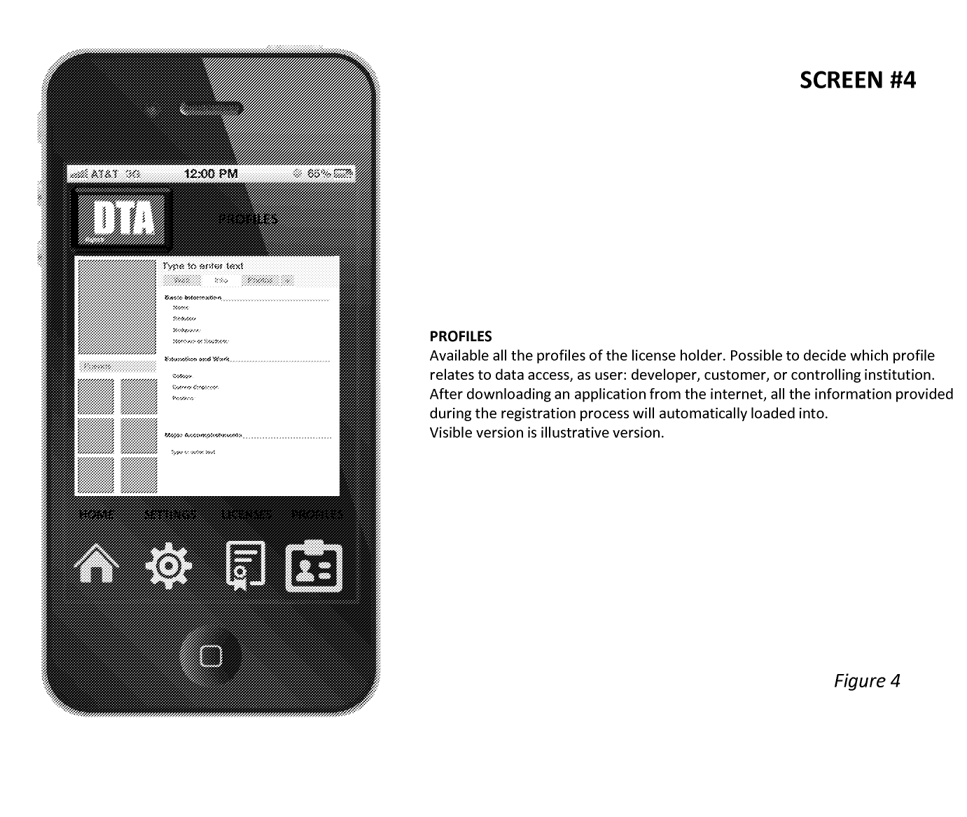

When you click “PROFILES,” the screen goes to the screen shown in FIG. 4. This screen shows all the profiles of the license holder. You can decide which profile relates to access to data, as user: developer, customer, or controlling institution.

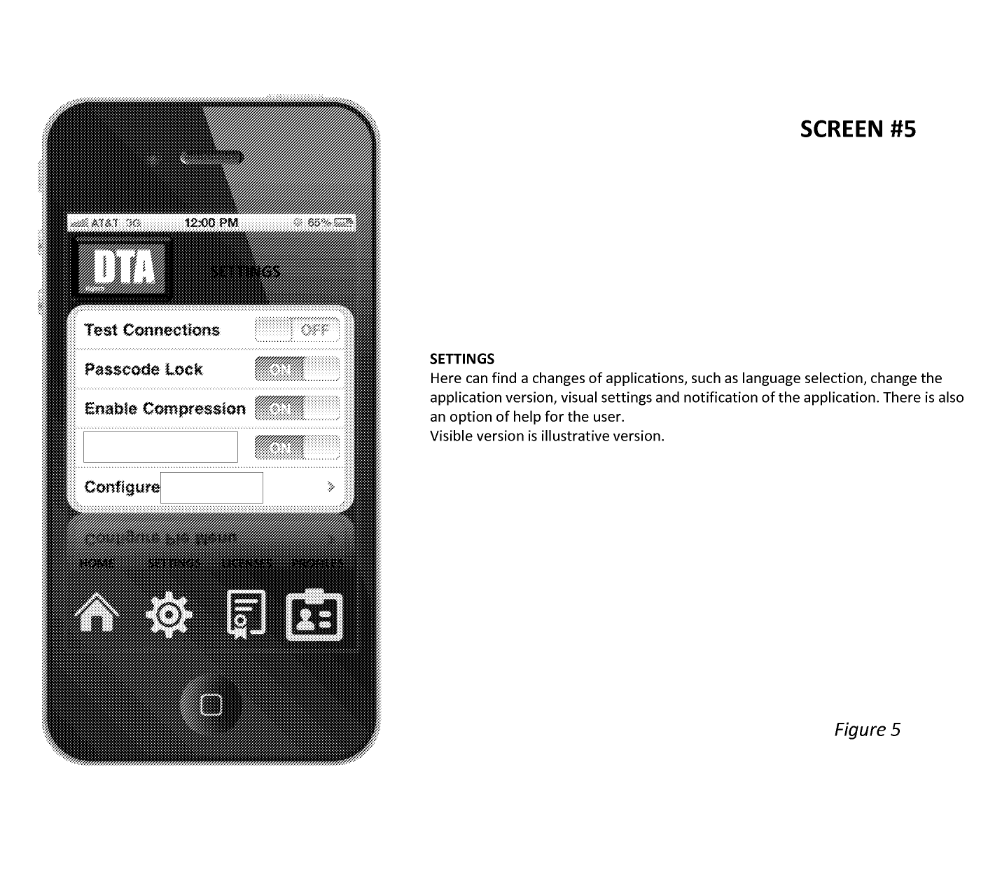

When you click “SETTINGS,” the screen goes to the screen shown in FIG. 5. This screen shows changes of applications, such as language selection, change version of the application, the application visual settings, notifications and alerts. There is also an option to help facilitate the use of the program to the user.

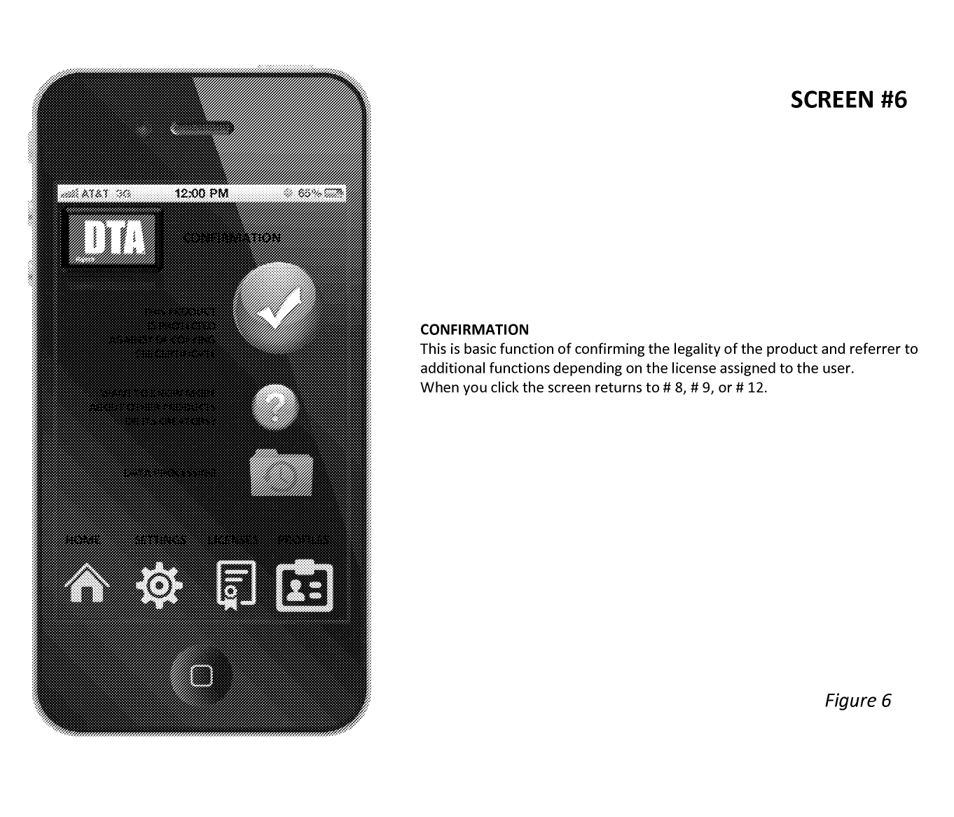

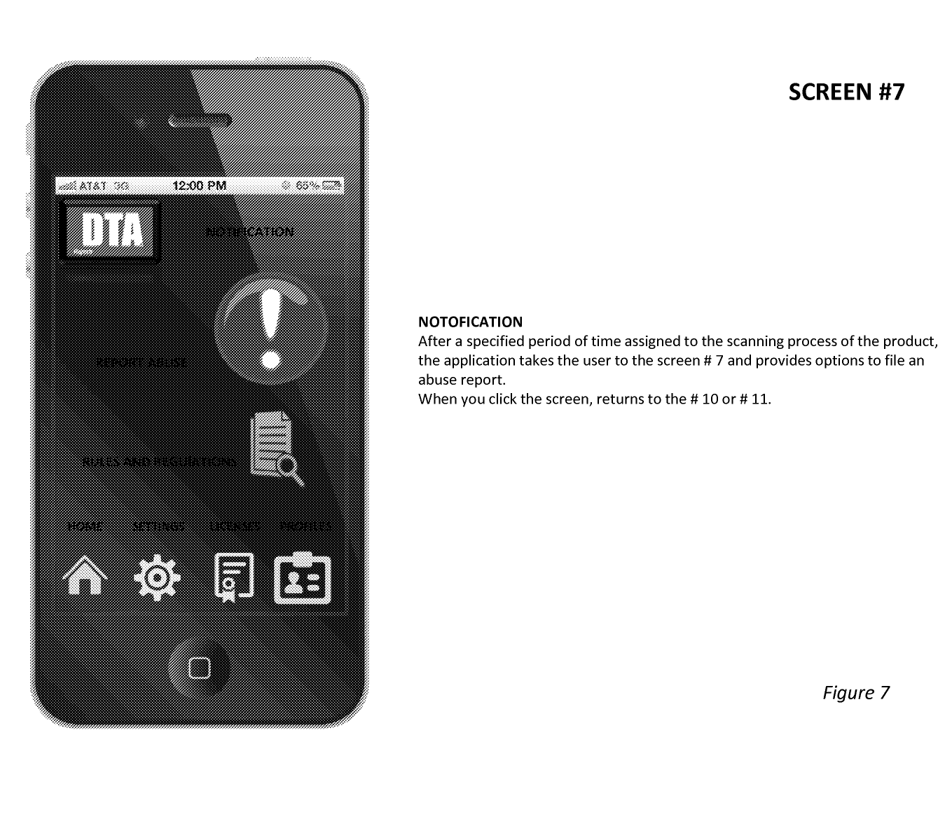

When “SCAN THE PRODUCT” is selected, the screen goes to the screens shown in FIG. 6 or 7. This is the basic function of confirming the legality of the product and refers to additional functions depending on the license assigned to the user.

Referring to FIG. 3, when one selects “LICENSE” only the selected/purchased version of a license/permit will be displayed here. This screen serves mainly to verify the powers of control authorities. Verification using the QR code allows for further authentication of persons acting on behalf of the control bodies.

Referring to FIG. 4, this screen displays all the profiles of the license holder. Here one can decide which profile corresponds to access to the assigned level of access data, as a user: a creator, a customer, or a representative of the controlling institution. After downloading the application from the Internet, all the information provided during the registration process will automatically load.

Referring to FIG. 5, this screen shows the settings available for the application, such as selection of language, change of the application version, visual settings of the application and notifications. There is also an option to help facilitate the use of the program to the user. The version visible is a demonstrative version.

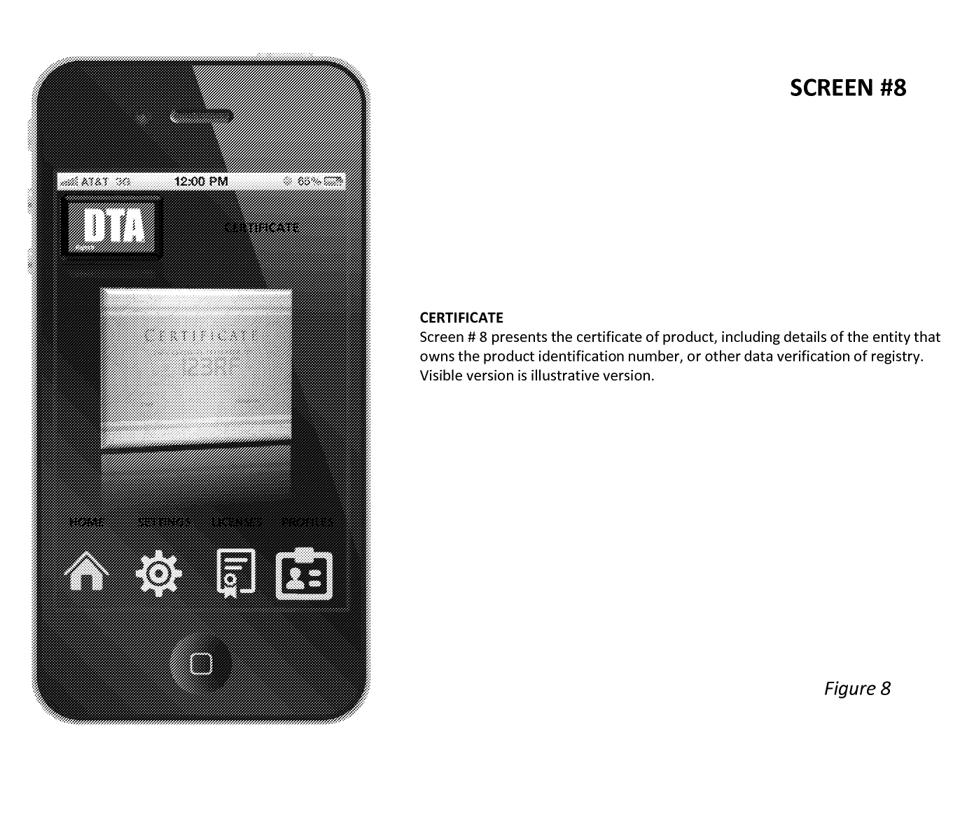

Referring to FIG. 6, this screen shows the confirmation function. If a system marker/tag is found on a product registered in the system, the screen refers to additional functions. Depending on the license assigned to the user, the application offers the user the opportunity to see the certificate, or to obtain additional information. When the confirmed function is selected, the application then goes to the screen of FIG. 8, 9 or 12.

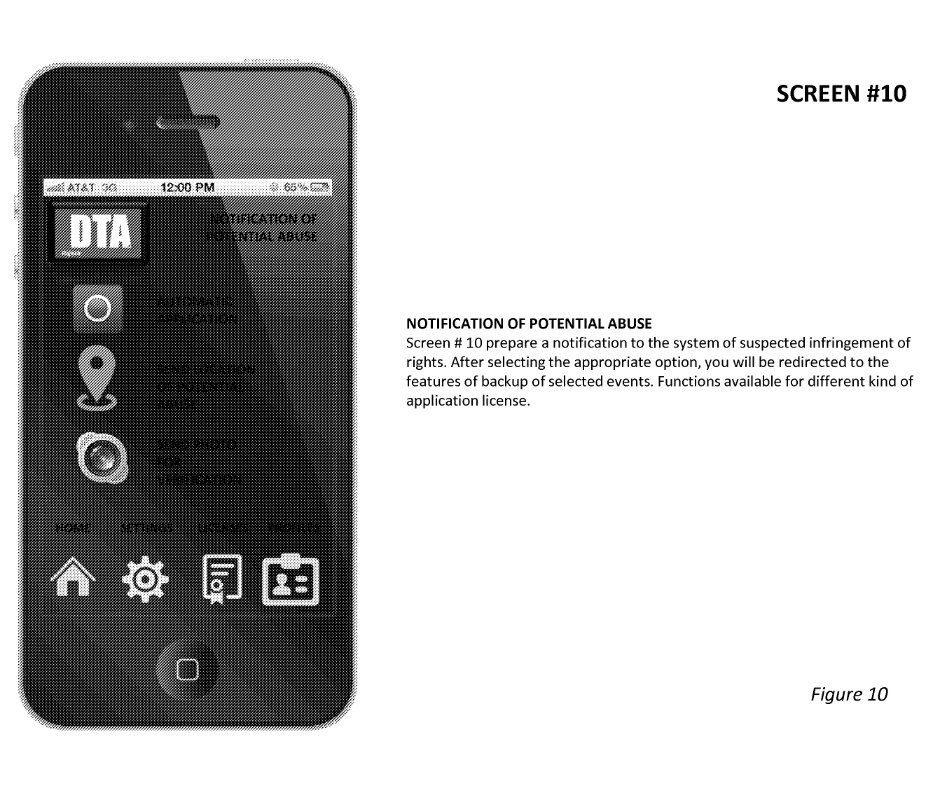

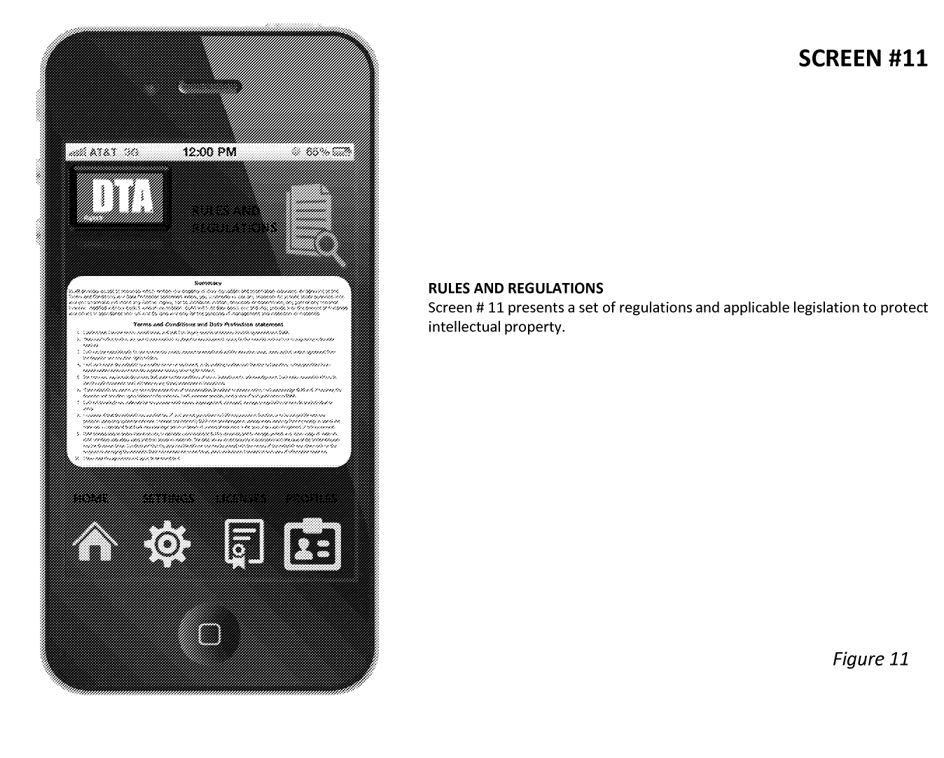

Referring to FIG. 7, after a certain time, the application takes the user to this screen and provides additional options. In case of lack of confirmation of marking on the product, suspected illegal distribution, or lack of labeling of the product due to the lack of product in the database registry, the application allows selected operations, within the operation of the registry, depending on the level of user access (e.g. the filing of an abuse report). After clicking on “NOTIFICATION,” the application goes to the screen of FIG. 10 or 11.

Referring to FIG. 8, this screen presents the product certificate to the user, including details of the entity that owns the product, identification number or other registry verification data.

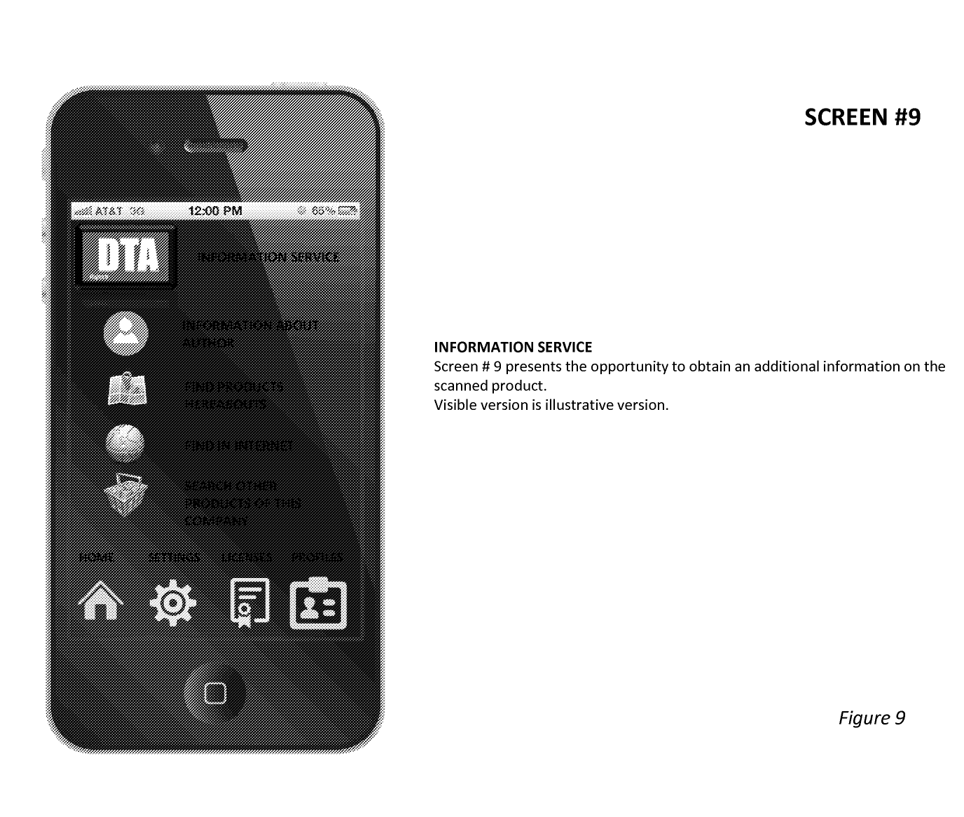

Referring to FIG. 9, this screen presents the application options that can provide such things as: Information about the author, searching for other products by the same author, searching for other points of distribution in the vicinity, searching additional options in the network, searching similar products. The system allows access to external applications, portals, downloading resources on the basis of authentication, etc.

Referring to FIG. 10, this screen allows the user to: automatically report abuse when it is sure that the product should have been labeled (available for trusted users to avoid unverified calls), execute photographic documentation and send it to the registry to verify the legality of a product by an authorized control body, mark the place of inspection by geotagging. The functions allowing detailing have developed identification mechanisms used by the system to verify the exact circumstances of controls of a selected product. After selecting the appropriate option, you will be redirected to the features of backup of selected events. Functions available for different kind of application license.

Referring to FIG. 11, this screen displays rules and regulations regarding the protection of intellectual and material property. This information will support primarily control institutions.

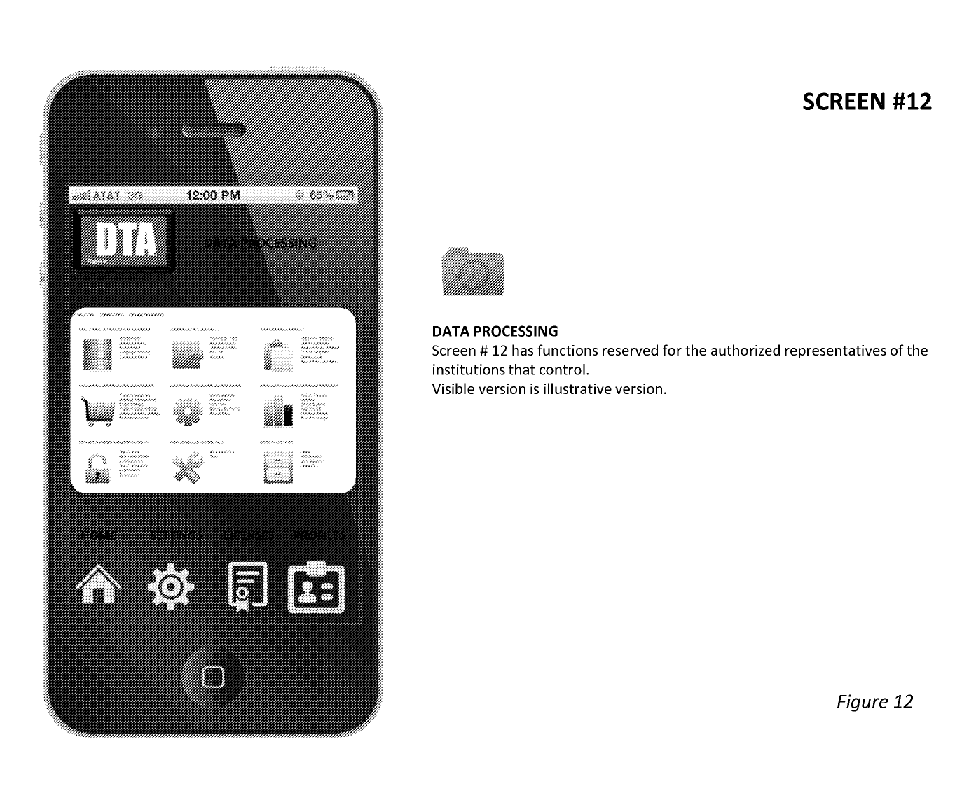

Referring to FIG. 12, this screen has functions reserved for the authorized representatives of control institutions. These include: downloading additional support applications and access to authorized system resources; options for managing the work of representatives of the control institutions and information collected during the identification of markers/tags during an inspection. The version visible is a demonstrative version.

Scanning the product using a mobile application using the built in smartphone communication solves and confirms the authenticity identification of a product in an encrypted way at the same time of the inspection of the product.

The system is maintained and regularly updated by the target operator, and the system includes the option to integrate with all available operating systems. There are several methods of valuation using the system, including free downloadable versions for end users. None of these options is limiting. The functionality of the application is open and is limited only to the scope of activities and the requirements laid down in specific cases of its operation.

The invention provides a communication system with DTA registry architecture, and it combines known technologies of the Internet, NFC, and the mechanism of product location, geotagging, with the possibility of full identification, and implementation of storage systems, and a smartphone, thus creating a mobile tool to protect the copyright and industrial rights, as well as the legality of the product.

The invention provides a method of communication with DTA registry architecture, wherein the application start page is the starting point for the application and all of its features and functions available. After selecting “LICENSES,” a purchased version of the license/permit is displayed. Under “PROFILES,” verification using the QR code authenticates a person acting on behalf of control bodies and all the profiles of the license holder are available and one can decide which profile is for access to the assigned level of access data as a user: creator, customer, or representative of the controlling institution In “SETTINGS,” application changes are available here, e.g.: selection of a language, changing the version of the application, the application visual settings and notifications, and the help option to facilitate the use of the program to the user.

In “SCAN THE PRODUCT,” the user can search for the label/tag by the system on the product registered in the system and the screen refers to additional functions, depending on the license assigned to the user and the application offers the opportunity to see the certificate, or obtain additional information. If a function is selected, the application refers to FIG. 8, 9 or 12.

After a period of time an application takes the user to the screen of FIG. 7 and provides additional options. In case of lack of confirmation on a product, suspected illegal distribution, or lack of labeling of the product due to the lack of product in the database registry and depending on the level of user, the application allows access to the selected operations within the operation of the registry. Upon clicking it, the application goes to the screen of FIG. 10 or 11.

The screen of FIG. 8 presents a product certificate to the user, including details of the entity that owns the product, identification number or other data verification registry.

The screen of FIG. 9 presents the application options that can retrieve information about the author, search for other products by the same author, search for other points of distribution in the vicinity, search additional options in the network, and search similar products. The system allows access to external applications, portals, download resources on the basis authentication.

The screen FIG. 10 allows the user to automatically report abuse, execute photographic documentation and send it to the registry to verify the legality of a product by an authorized control body, mark the place of inspection by geotagging.

The screen of FIG. 11 presents a set of rules and regulations regarding the protection of intellectual and material property.

The screen of FIG. 12 has functions reserved for the authorized representatives of control institutions that include: downloading additional support applications and access to authorized system resources, options for managing the work of representatives of the control institutions and information collected during the identification of markers/tags during an inspection.

1. A communication system having access to a DTA registry architecture comprising:
an NFC component;
a mechanism of product location, geotagginig
a mechanism for full product identification;
a mechanism for accessing storage systems
a smartphone such that said system creates a mobile tool to protect the copyright and industrial rights as well as the legality of a product.

2. A method of communicating with a DTA registry architecture comprising
Obtaining a license to access said DTA registry
scanning a product to search for a tag via NFC technology;
comparing information obtained from scanning to information from said DTA registry;
confirming or denying the authenticity of said product based on said comparing.

3. A method according to claim 2, further comprising providing a notice to said registry of legality of illegality of said authenticity.
